(19) United States
(12) Patent Application Publication
(10) Pub. No.: US 2026/0088331 A1
(43) Pub. Date: Mar. 26, 2026

(54) FLEXIBLE FRAME FOR USE IN APPLYING HIGH PRESSURE IN THE MANUFACTURE OF A SOLID-STATE BATTERY CELL

(71) Applicant: Solid Power Operating, Inc., Louisville, CO (US)

(72) Inventor: David A. TELEP, Longmont, CO (US)

(21) Appl. No.: 19/341,895

(22) Filed: Sep. 26, 2025

Related U.S. Application Data
(60) Provisional application No. 63/699,688, filed on Sep. 26, 2024.

(51) Int. Cl. H01M 10/04; H01M 10/0585

(52) U.S. Cl. CPC H01M 10/0468; H01M 10/0585

(57) ABSTRACT

Systems and methods of producing a solid-state battery cell using an isostatic press system to apply a substantially uniaxial load on the flat surfaces of the cell, while limiting or eliminating the pressure applied to the sides and outside of the cell. The cell frame is provided that may include a top plate and a bottom plate between which the battery cell may be located. The top and bottom plates of the frame may include a hollow center covered with a polymer or other flexible, liquid-impervious, material. An outer portion of the top and bottom plates may comprise a frame to support the polymer center portion. In some implementations, the frame may comprise a metal material.

### CROSS-REFERENCE TO RELATED APPLICATION

This application is related to and claims priority under 35 U.S.C. § 119 from U.S. Provisional Application No. 63/699,688 filed Sep. 26, 2024, titled “Flexible Frame for Use in Applying a High Pressure in the Manufacture of Battery Cell,” the entire contents of which are fully incorporated by reference herein for all purposes.

### TECHNICAL FIELD

Various embodiments to the field of solid-state primary and secondary electrochemical battery cells, electrodes, and electrode materials, and more particularly to a fixture for supporting the same for processing in an isostatic press.

### Background and Introduction

The ever-increasing number and diversity of mobile devices, the evolution of hybrid/electric automobiles, and the ongoing evolution of countless battery cell powered devices are motivating development of battery cell technologies with improved reliability, capacity, thermal characteristics, lifetime and recharge performance. Currently, solid-state battery cell technologies offer potential increases in safety, packaging efficiency, and enable new high-energy chemistries as compared to other types of batteries. Nonetheless, improvements in battery cell technologies are needed, including improvements in production efficiency.

It is with these observations in mind, among others, that various aspects of the present disclosure were conceived.

### SUMMARY

One aspect of the present disclosure relates to a frame for protection of an electrochemical battery cell during pressing. The frame may include a bottom plate mated with a top plate, each comprising a rigid outer perimeter and an inner portion comprising a flexible material. The layer of the electrochemical cell is sealed between the bottom plate and the top plate for pressurizing through an isostatic pressing (using an isostatic press) applying a uniaxial pressing force through the flexible material of the bottom plate and the top plate onto the electrochemical cell.

Another aspect of the present disclosure relates to a method for applying force to layers of a battery cell. The method may include the operations of loading an electrochemical cell in a bottom plate of a frame, the bottom plate comprising a first rigid outer perimeter and a first inner portion comprising a flexible material, mating the bottom plate with a top plate to encase the electrochemical cell within the frame between the top plate and the bottom plate, the tope plate comprising a second rigid outer perimeter and a second inner portion comprising the flexible material, and pressurizing, through an isostatic press, the electrochemical cell, the isostatic press applying a uniaxial pressing force across a layer of the electrochemical cell through the first inner portion and the second inner portion via the flexible material.

These and other aspects of the disclosure are described in additional detail in the description that follows.

### BRIEF DESCRIPTION OF THE DRAWINGS

FIGS. 1A-1C are side views of example battery cells, according to aspects of the present disclosure.

FIG. 2 is an isometric view of a top plate of a housing device, a battery cell, and a bottom plate of the housing device used for isostatic pressing of the battery cell, according to aspects of the present disclosure.

FIG. 3 is a cross-section view of a battery cell located within a housing with flexible sides for applying substantially uniaxial pressure to a solid-state battery cell within an isostatic press, according to aspects of the present disclosure.

FIG. 4 is a diagram illustrating an overhead view of the housing of FIG. 3 for applying opposing uniaxial pressure to opposing surfaces of a solid-state battery cell within an isostatic press, according to aspects of the present disclosure.

FIG. 5 is a diagram of a cross section of the top plate of a housing device and the bottom plate of the house device coming together and encasing around a battery cell, according to aspects of the present disclosure.

FIG. 6 is a flowchart of a method for utilizing a partially flexible housing for applying substantially uniaxial pressure to a solid-state battery cell within an isostatic press, according to aspects of the present disclosure.

### DETAILED DESCRIPTION

Solid-state battery cells use solid electrolytes, instead of liquid electrolyte layers, to create potentially safer batteries with higher energy densities as compared to some liquid electrolyte type batteries. In general, the battery cell often comprises a layered structure that includes an anode and a cathode separated by a solid electrolyte. The layered structure may include multiple layered units of anode, electrolyte, and cathode. In some cases, the layered structure, often referred to as a “stack,” is encased in a flexible laminate structure, which may be referred to as a pouch. A flexible pouch is used in some solid-state batteries because the encased layered cell structure expands and contracts during charge and discharge, and the flexible pouch accommodates such expansion and contraction. In many instances, the pouched cell defines opposing planar surfaces with planar tabs, one connected to the anode(s) and one connected to the cathode(s) of the interior cell stack by way of anode and cathode current collectors, with the tabs extending from a side or opposing sides of the pouch, although other arrangements are possible. Aspects of the present disclosure apply to a battery cell stack (prior to being encased in a pouch) and/or a pouched battery cell, or other discrete electrode or cell arrangements where lamination and/or densification is needed or beneficial.

The term “battery cell” in the art and herein can be used in various ways and may refer to an individual cell having an anode and cathode separated by an electrolyte, as well as a collection of such cells connected in various arrangements. A battery or battery cell is a form of an electrochemical device. Batteries generally comprise repeating units of sources of a countercharge and electrode layers separated by an ionically conductive barrier, in some cases a liquid or polymer membrane saturated with an electrolyte. These layers are made to be thin so multiple units can occupy the volume of a battery cell, increasing the available power of the battery cell with each stacked unit. Although many examples are discussed herein as applicable to a battery cell, it should be appreciated that the systems and methods described may apply to many different types of batteries ranging from an individual cell to batteries involving different possible interconnections of cells, such as cells coupled in parallel, series, and parallel and series. For example, the systems and methods discussed herein may apply to a battery pack comprising numerous cells arranged to provide a defined pack voltage, output current, and/or capacity. Moreover, the implementations discussed herein may apply to different types of electrochemical devices such as various different types of batteries and solid-state batteries of various possible chemistries, to name a few. Further, although the below is applicable to solid-state battery cells, it should be appreciated that the below may also apply to components or aspects of a liquid electrolyte battery, if not the entire liquid electrolyte battery, for reasons that should be clear from the description. For example, the below described systems and methods may be utilized to densify electrode layers for use in a liquid electrolyte battery. The various implementations discussed herein may also apply to different structural battery cell arrangements such as button or “coin” type batteries, cylindrical battery cells, pouch battery cells, and prismatic battery cells.

In some aspects and referring particularly to solid-state battery cells, densifying the layers forming the battery cell aid in the efficient operation of the battery cell by reducing the porosity of the materials within the stack (or increasing the density of the materials), enhancing material contact within and between layers, and/or causing some layers to bond. Densification and/or enhancing material contact between the layers of the battery cell may be improved by applying a force, which may be considered in some instances a compressive force, to the layers of the battery cell. By compressing the layers, the porosity of the materials of the battery cell may be reduced and contact between the layers may be increased, resulting in a more efficient and higher-performing battery cell.

As such, aspects of the present disclosure involve the application of pressure to a solid-state battery cell stack to laminate the stack layers together and/or densify the materials of the various layers. In one aspect of the present disclosure, an isostatic press may be used to apply a uniform pressure to the layered cell structure. In general, the implementations discussed herein may include any type of isostatic pressing device. In one particular implementation, a warm isostatic press (WIP) may be utilized. Although discussed herein as including a WIP, it should be appreciated that the devices, methods, systems, and the like discussed may apply to any isostatic press. Thus, although the term “warm, isostatic press” and “WIP” may be used herein, other isostatic presses are contemplated for use with the disclosed embodiments. An isostatic press, including a WIP, generally involves application of a uniform pressure onto every surface of an object within the press and exposed to a pressurized fluid or gas. As the cell stack defines relatively large parallel planar surfaces and relatively small dimension side walls extending between the planar surfaces, the pressurized fluid of the WIP primarily applies opposing forces on the planar surfaces of the stack, thereby laminating the layers of the stack and/or densifying the material of the stack layers. Pressing the cell stack with the uniform opposing pressure of a WIP device may allow for a more consistent lamination and may help avoid cracking tied to non-uniform force. Further, large WIP units may also be viable for mass production by applying pressure to several battery cell stacks at the same time, increasing the efficiency of battery cell manufacturing.

Although the use of WIP to pressurize a solid-state battery cell has some benefits, many challenges may arise. For example, use of the WIP may require additional battery cell preparation and cleanup. In addition, many WIP devices use water as the fluid within the device. However, water can damage or corrode battery cell leads. Secondary pouching or reliable masking of the metal tabs may therefore be considered. In other instances, an oil may be used as the fluid of the WIP, which may require post processing to remove oil from battery cell. In still other uses, the WIP may include a pressurized gas, such as hydrogen, nitrogen, carbon-dioxide, argon, and the like.

If a battery cell stack is simply processed directly in a WIP, it may cause mechanical damage to the battery cell, resulting in shorter battery cell life or potential for a short within the battery cell itself. For example, the WIP applies pressure equally to all surfaces. However, the edges and sides of the battery cell stack, without protection, may be susceptible to damage at high pressures. Similarly, without protection, pressure applied to the tab and/or weld areas of the battery cell pouch may also be more susceptible to damage due to high pressure. For example, some of the layers of the battery cell may be bent up or down during the compression of the cell in the WIP. Layers near the edge of the battery cell may, through the application of a force near the edge of the cell, be brought together as the layers are pinched. However, the pinching of the layers may cause unsafe operating conditions of the battery cell. For example, two or more conductive layers of the battery cell may come into contact during the pressing of the cell and cause a short condition between the layers. In other examples, severe bending of the layers may cause damage to the layers, such as a cracking or other deformities within the layers.

Aspects of the present disclosure involve systems and methods of producing a solid-state battery cell using an isostatic press system to apply a substantially uniaxial load on the flat surfaces of the battery cell for laminating and/or densifying layers (e.g., electrode and separator layers) of the battery cell, while limiting or eliminating the pressure applied to the sides and outside of the battery cell to minimize or reduce damage to those portions of the battery cell. In some arrangements, the substantially uniaxial force is perpendicular to the large planar surface(s) of the battery cell and portion of the battery cell being laminated or densified. In general, aspects of the present disclosure involve a frame that supports the battery cell withing an isostatic press. The frame abuts the side walls of the battery cell and encloses the tabs, while defining a first and/or a second window opening each covered by a flexible resilient fluid impervious material parallel with an immediately adjacent an upper and/or lower planar surface of the battery cell housed in the frame. The uniaxial force from the fluid in the WIP is applied to the flexible resilient material and also applied to the battery cell through the window (or windows) by nature of the material's flexibility while simultaneously blocking fluid from contacting the battery cell. In one implementation, a battery cell frame is provided that includes a receptacle for a battery cell. The frame may include a top plate and a bottom plate between which the battery cell may be located. The top and bottom plates of the frame may include a hollow center (e.g., windows) covered with a polymer or other flexible, resilient liquid-impervious, material. An outer portion of the top and bottom plates may comprise a frame to support the polymer center portion. In some implementations, the frame may comprise a metal material. In general, however, the window covering material and frame material should be impervious to liquids at high pressures and temperatures.

The layers of the battery cell (either pouched or pre-pouched) may be stacked and placed in between the top and bottom plates of the frame. In some implementations, the bottom plate may include a recess receiving at least a portion of the battery cell to hold the battery cell in place between the top and bottom plates. Once the battery cell is placed within the recess, the top and bottom plates of the frame may be mated to house the battery cell within the frame. In some implementations, the top and bottom plates may be locked together to seal around the stacked layers. In still other implementations, a gasket or other liquid-impervious layer may be included between the top plate and the bottom plate to prevent liquid from entering the frame and contacting the battery cell. In still other implementations, the top or bottom plates may include a raised outer edge that mates with a corresponding indention in the other portion to further seal the battery cell within the frame. Further, the top and/or bottom plates of the frame may include recessed areas in which the tabs and/or weld areas of the battery cell may be located to lower or prevent pressure from being applied to such delicate portions of the battery cell.

Once mated, the frame and stacked layers inside may be placed in an isostatic press where pressure is applied to all sides through a pressurized liquid. The rigid frame of the top and bottom plates generally prevents the layers of the battery cell from bending or buckling. In a similar manner, the recessed areas of the frame may prevent damage to the tabs and/or welds of the battery cell. The frame may also help to prevent the movement of any pouch materials that were used in the battery cell. As the pressure from the isostatic press is applied to the frame, the polymer layers act as a flexible barrier that 1) prevents the pressing fluid from contacting the layers and 2) allows for a near uniform and unilateral isostatic pressing effect on the flat surface(s) of the battery cell adjacent the frame openings covered by the flexible layer. As the pressure is increased, the polymer conforms to the surface of the top and bottom of the enclosed battery cell and allows for even pressure distribution across the outer faces of the battery cell. In some implementations, the window of the polymer material may be sized such that the isostatic pressure is only applied to an area the is equivalent to the surface area of the smallest layer of the battery cell, typically the cathode layer, although other battery cell configurations may be utilized.

When processed in the isostatic press, the side walls, tabs, weld portions, etc. of the battery cell are protected and the pressure of the fluid within the isostatic press produces a force on the top surface and the bottom surface of the stack through the flexible portions of the frame. The pressure on the battery cell stack or the sleeve encompassing the battery cell stack produces a substantially uniaxial force across the surface when the fluid in the press is pressurized. The distributed force is uniform due to the nature of the isostatic press and the configuration of the frame. In particular, the uniaxial force is substantially perpendicular to the top and bottom surface of the battery cell such that the force applies a distributed relatively uniform laminating force to the battery cell stack. As noted, the force may also densify layers of the battery cell stack. The outer, metal portions of the frame may cover over small gaps where the sidewalls of the battery cell may be exposed and thus block fluid and the pressure from the same from entering and applying forces into those areas, thus restricting the force to the areas where it can laminate and/or densify.

In instances in which the battery cell stack includes tabs extending from the stack, the top or bottom plates of the frame may include a portion to receive and isolate the connection tab from the isometric pressure. Various tab configurations are possible and the recessed portions may be shaped according to the size and type of battery cell stack to be processed, including accommodation various alternative tab arrangements and use of pouched or unpouched battery cell stack. In one configuration, any given frame includes two tab portions each dimensioned such that the tabs may be positioned in the tab portion. In addition, the recessed portion for the battery cell stack in the bottom plate of the frame may include a shelf around the recess to support one or more layers of the battery cell stack that are larger in surface area than other layers of the battery cell stack. As mentioned above, the window of the polymer material of the frame may be sized such that the isostatic pressure is only applied to an area the is equivalent to the surface area of the smallest layer of the battery cell, typically the cathode layer. Thus, some implementations may include a shelf around the battery cell stack recess in the bottom layer to support the surface area of the larger layers of the battery cell.

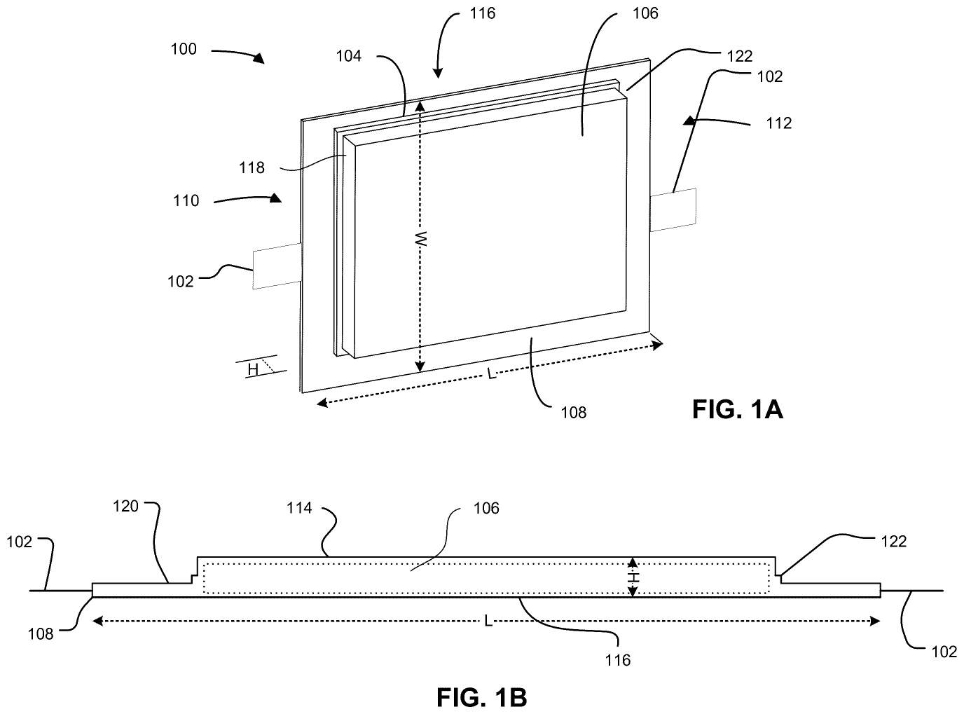

The composition of the battery cell stack which may be pressurized through the isostatic press described herein may take many forms. FIG. 1A is an isometric view of one possible example of a conventional pouch battery cell 100 for use with the isostatic press. Although described herein as applying to a conventional pouch battery cell 100, it should be appreciated that the devices, systems, methods, and the like described herein may equally apply to unpouched battery cell stacks. For example, the isostatic press may be used with battery cell stacks which are then used in prismatic battery cells. In general, the systems and methods described herein are not limited to pouch battery cells, but such battery cells may be used as an example for use with the implementations described herein.

In this example, the pouch battery cell 100 is generally rectangular in shape with conductive tabs 102 extending from opposing ends of the pouch battery cell. The conductive tab 102A extending from one end of the pouch battery cell is connected with the anode of the electrochemical battery cell inside, typically at a current collector, and the conductive tab 102B at the other end of the pouch battery cell is connected with the cathode of the electrochemical battery cell 106, also at a current collector. Pouch battery cells may be of varying configurations including different shapes, such as the shape of a rectangle or square in possible examples. In the example illustrated in FIGS. 1A and 1B, the pouch battery cell 100 includes a sealed rectangular periphery 104 around the enclosed battery cell 106. The sealed periphery 104 is located where the outer flexible pouch material layers extend beyond the encapsulated area of the layered battery cell structure, such as electrochemical battery cell 106, within the bonded and sealed layered structure of the pouch. In addition, the battery cell structure may, in some instances, include layers of varying surface areas such that some layers have a larger surface area than other layers. As illustrated in FIG. 1A, the battery cell stack may include one or more layers 122 that are larger than other layers such that the battery cell stack may extend out from the smaller layers and is not necessarily of a uniform area.

FIGS. 1A and 1B illustrate a lower sheet 108 as planar and the electrochemical battery cell structure 106 is on the sheet and projecting upward from the sheet. An upper sheet is placed over the battery cell structure and the upper and lower sheets are bonded along the periphery 104. The pouch battery cell has an overall length and width with a portion 118 encapsulating the battery cell structure 106 having a length (L) and a width (W) each less than the overall length and width of the pouch battery cell due to the periphery 104, as well as the tabs if considered part of the length. As noted, some battery cell structures 106 may include layers of varying surface areas such that some larger layers 122 may extend outward from the smaller areas. The portion 118 also includes a height (H). In this example, the conductive tabs 102 are located at opposing ends of the pouch battery cell. The battery cell generally has a first surface 114 and a second surface 116 over which the isostatic pressing force is applied to laminate and/or densify the layers of the battery cell stack.

In the example of FIGS. 1A and 1B, conductive tabs 102 are located in a lower plane relative to height (H) dimension. It should be noted that conductive tabs 102 could be located at any suitable height (H) dimension in various possible embodiments of the present disclosure. The tabs may also extend from the same side or may extend from pouch battery cell in other ways to conform to whatever end use for the pouch battery cell. FIG. 1C is another example of a pouch battery cell similar to the example of FIGS. 1A and 1B, with the primary distinction that the tabs 102 extend from about a midpoint of the encapsulated battery cell 106 as opposed to along the planar bottom surface of the battery cell. The conductive tabs 102A, B in this implementation are located in a plane that corresponds to about the middle of the height (H) dimension of the pouch battery cell. It should be noted that conductive tabs 102A, 102B could be located at any suitable height (H) dimension in various possible embodiments of the present disclosure. In addition, the conductive tabs 102A, 102B may be welded or otherwise electrically connected to one or more layers of the battery cell. This weld area 120 may be encased within the pouch of the battery cell and may extend away from the inner layers of the battery cell between the conductive tabs 102A, 102B and the battery cell stack 106. Such weld areas 120 generally include a larger height and width than the conductive tabs 102A, 102B.

Regardless of if the type of pouch battery cell used, the stack of layers of material of the internal battery cell structure 106 may be laminated using a frame and an isostatic press. As noted, while discussed relative to a pouched battery cell, the isostatic process and devices described herein may be used to laminate a battery cell stack prior to pouching, densify discrete battery cell components such as an anode or cathode or combinations of the same, among other uses where lamination and/or densification of an electrochemical structure would be beneficial. In some instances, the isostatic press is filled with a fluid, such as water or oil, that is pressurized to apply a pressing force to the submerged and housed battery cell structure between 20k-60k pounds per square inch, in some embodiments. One additional advantage of using a sleeve is that the battery cell is protected from exposure to whatever the fluid used in the press. In addition, the fluid may be warmed up to 90 degrees Celsius, which may be considered a warm isostatic press or WIP. The combination of warmth and pressure may be further beneficial for lamination of the layers. As noted, the system may also densify the layers, or further densify the layers if the battery cell structure was densified prior to processing in the isostatic press.

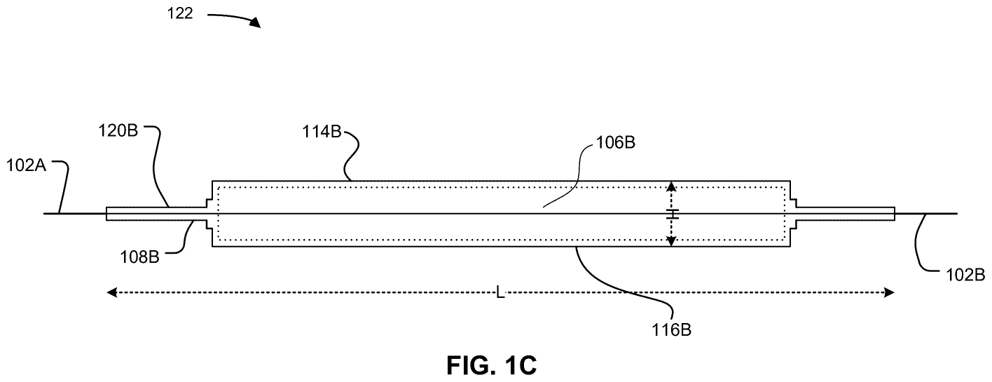

FIG. 2 is an isometric view of a top plate 202 of a housing device, a battery cell 206, and a bottom plate 204 of the housing device used for isostatic pressing of the battery cell. As described above, the battery cell 206 is generally rectangular in shape with or without conductive tabs extending from opposing ends of the battery cell. A bottom plate 204 of the housing device may have a similar shape as the battery cell 206 and include a center recess 208. The center recess 208 may include dimensions similar to that of the battery cell 206. For example, the center recess 208 have a width and length similar to that of a battery cell 206 without conductive tabs for receiving the battery cell. In another example, the center recess 208 may include other recesses to accommodate the dimensions of a battery cell with conductive tabs, such as a recess for weld portions and/or conductive tab portions of the battery cell as described in more detail below. In general, the center recess 208 may be shaped to receive the battery cell. In some instances, the depth of the center recess 208 may allow some portion of the height of the battery cell to extend above the rim of the center recess.

The top plate 202 may include a corresponding and similar center recess on the bottom surface of the top plate. The center recess of the top plate 202 may be shaped to receive a top portion of the battery cell. For example, a battery cell 206 may be located between the top plate 202 and the bottom plate 204 and, when the top plate and the bottom plate are brought together or otherwise mated, the battery cell may be encased within the center recesses of the plates.

In some instances, one or more alignment pins and a corresponding alignment hole may be included in the top plate 202 or the bottom plate 204 to ensure the plates are flush when mated. Further, the housing 200 may, in some instances, be inserted into a fluid-proof pouch to prevent the pressing fluid of the WIP from entering the housing during pressing. Alternatively, the top plate 202 and/or the bottom plate 204 may include a clamping device to clamp the top plate to the bottom plate and prevent or reduce any fluid from entering the housing.

In general, the center recesses 208 are shaped to hold the battery cell in place within the housing 200 and protect certain portions of the battery cell from damage due to isometric pressure. For example, after sealing the battery cell within the housing between the top plate 202 and the bottom plate 204, the housing may be placed within an isometric press. The isometric press may generate a pressing force on the outside of the housing 200 which is transferred to the layers of the battery cell 206 encased within the housing. As described in more detail below, the top plate 202 and the bottom plate 204 may include a flexible center portion oriented above and below the battery cell 206. The pressing force from the press may be transferred through the flexible portion of the plates onto the flat surfaces of the battery cell 206 to laminate and/or densify the layers within. Further, the housing 200 may protect other portions of the battery cell 206, such as the weld area and/or the conductive tabs, from the isometric pressing force to remove or lessen any damage done to these sensitive areas.

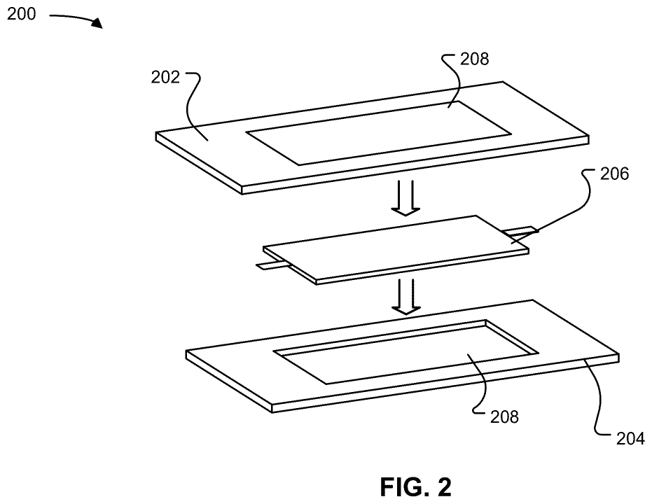

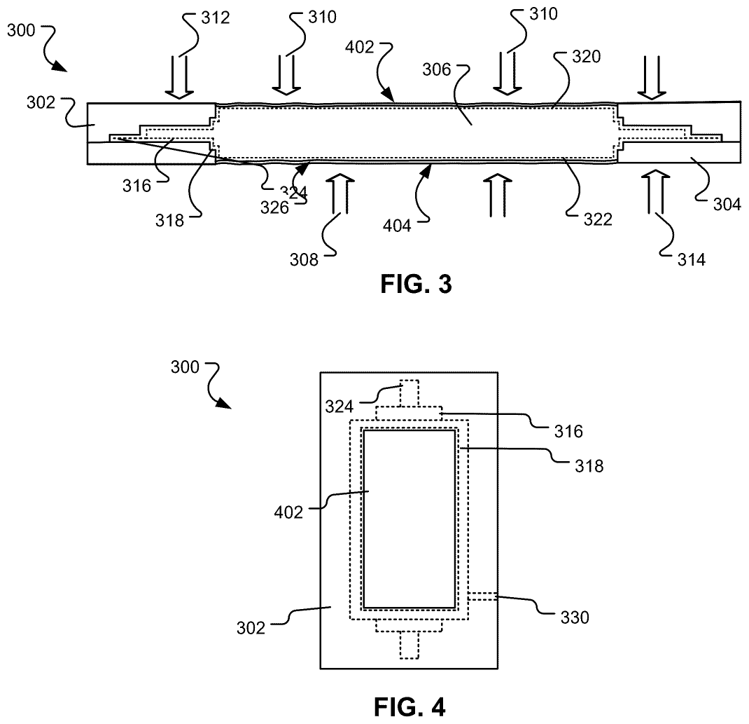

FIG. 3 is a diagram illustrating a cross-section view of a frame 300 for holding a solid-state battery cell within an isostatic press such that a pressure force is applied to a top and bottom region of the solid-state battery cell, according to aspects of the present disclosure. FIG. 4 is a top view of the frame of FIG. 3. In this embodiment, the frame 300 may include a top plate 302 and a bottom plate 304 similar to the top plate and bottom plate described above. As also described above, a battery cell 306 or stack of battery cell layers may be located within the frame 300 between the top plate 302 and the bottom plate 304 when the top plate and the bottom plate are mated. As best seen in the overhead view of FIG. 4, the top plate 302 (and the bottom plate 304, although not shown in FIG. 4) of the frame 300 may include a hollow center 402 covered with a polymer or other flexible, liquid-impervious material. In other words, the top plate 302 and bottom plate 304 may include a window 402 or hole through the frame that is covered with the polymer material. In some embodiments, the polymer-covered opening 402 may be rectangular shaped. However, for battery cells with shapes other than rectangular, the opening 402 in the top plate 302 and/or the bottom plate 304 may be shaped to correspond to the battery cell shape. Further, in some implementations, the opening 402 may be approximately the size of the smallest layer of the battery cell 306. For example, the battery cell 306 may include several layers, such as an anode layer, a cathode layer, etc. The layers of the battery cell 306 may vary in surface area, with some layers having a larger area than others. The opening 402 of the frame 300 may therefore be sized to be similar or otherwise correspond to the surface area of the smallest layer of the battery cell 306. In other instances, the opening 402 may be sized to correspond to the layer of the battery cell with the largest surface area.

Once mated, the frame 300 with the battery cell 306 sealed inside may be placed in an isostatic press where pressure 308-314 is applied to all sides through a pressurized liquid. As the pressure 308, 310 from the isostatic press is applied to the frame 300, the polymer layers 402, 404 of the top plate 302 and the bottom plate 304 act as a flexible barrier that prevents the pressing fluid from contacting the layers and allows for a near uniform and unilateral isostatic pressing effect on the flat surface of the battery cell layer and the layers inside. In other words, the opening 402 and polymer layer over the opening allow for the transfer of the pressing force 310 from the isometric press onto a top layer 320 of the battery cell stack within the frame 300. Similarly, the opening 404 and polymer layer over the opening allow for the transfer of the pressing force 308 from the isometric press onto a bottom layer 322 of the battery cell stack within the frame 300. In particular, as the pressure is increased within the press, the polymer conforms to the top surface 320 and bottom surface 322 of the battery cell 306 and allows for even pressure distribution across the outer faces of the battery cell.

In addition to allowing the pressuring force from the isometric press to laminate and/or densify the layers of the battery cell 306, the frame 300 may also protect more delicate portions of the battery cell. For example, the bottom plate 304 may include a recess 326 shaped to receive at least a portion of the battery cell 306 to 1) hold the battery cell and 2) protect portions of the battery cell from the pressured force 314. In general, the recess 326 of the bottom plate 304 of the frame 300 may mirror the general shape of the battery cell 306. For example and in addition to the opening 404 of the bottom plate 304, a recessed shelf 318 may surround the opening 404. The dimensions of the recessed shelf 318 may correspond to a larger layer of the battery cell 306 such that the larger layers extend out from the opening 402 and are supported or otherwise protected by the recessed shelf. This recessed shelf 318 may prevent a pressing force from the isometric press liquid from contacting and damaging the edges of the larger layers. For example, the operation of the battery cell may be damaged if one or more of the layers comes into contact with any other layer not adjacent to the layer. However, because some layers are larger than others and extend out from the stack, the application of a pressing force to these extending layers may cause the layers to fold and potentially come into contact. In some battery cell configurations, the folding of one or more layers may cause the battery cell to short or otherwise become ineffective. By locating the extending edges of these larger layers into the recessed shelf 318, the edges may be protected from the pressure forces of the isometric press such that the edges are not folded onto each other to damage the battery cell 306.

The top plate 302 of the frame 300 may include a similar shelf recess 318 to accommodate the edges of the larger layers of the battery cell 306 located near the upper portion of the battery cell. Further, for battery cells 306 that include a conductive tab 102 (and a corresponding weld portion 120, the top plate 302 may include a weld recess 316 and/or a tab recess 324. In the example illustrated in FIG. 3, the weld portion 120 of the battery cell 306 extends from the corresponding tab 102 toward the top of the battery cell. However, in some instances, the weld portion 120 may extend from the conductive tab 102 toward the top and the bottom of the battery cell 306. In such instances, the bottom plate 304 may include a corresponding weld recess 316 to accommodate the weld portion of the battery cell 306. In general, the top plate 302 and the bottom plate 304 may include recesses to accommodate the various shapes of battery cells and protect portions of the battery cell from the pressing force of the isometric press. In other words, the recesses of the frame 300 may provide for pressing forces through the polymer-covered openings 402, 404 on the upper and lower surfaces of the battery cell 306 (generally corresponding to the surface area of the smallest layer of the battery cell), while preventing the pressing force from damaging other portions of the battery cell (such as the extending edges of the larger layers 122, the weld area 120, the conductive tabs 102, etc.).

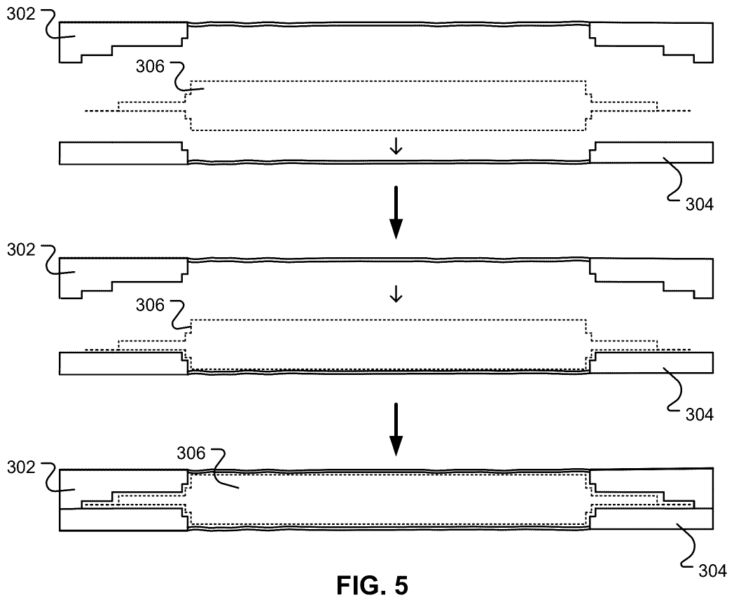

As noted above, the battery cell 306 may be placed within the recess of the bottom plate 304 or the top plate 302 of the frame 300 and the two portions of the frame may be mated. In some instances, the mating of the top plate 302 with the bottom plate 304 creates a sealed container in which the battery cell 306 is located. The sealed container may also prevent the liquid from the isometric press from contacting the battery cell 306 within the frame 300. FIG. 5 illustrates an orientation of the top plate 302 and the bottom plate 304 of the frame 300 to load a battery cell 306 into the frame. The portions of the frame 300 are the same or similar to those discussed above. In particular, the frame 300 includes a top plate 302 and a bottom plate 304, between which battery cell 306 may be located. Thus, FIG. 5 illustrates a cross-section of the frame 300 and a process through which the battery cell 306 is located between the top plate 302 and the bottom plate 304.

As illustrated, the battery cell 306 is placed against or within the recess of the bottom plate 304. The top plate 302 is then pressed against the battery cell 306 to mate the top plate 302 and the bottom plate 304. To aid in sealing the top plate 302 to the bottom plate 304, one or more gaskets may be placed between the plates. For example, a gasket may be located around any recessed areas of the top plate 302 and/or the bottom plate 304. This gasket may be made of a polymer, an inorganic composite, lead, magnesium, or combination thereof. Other gaskets may be used to further seal the top plate 302 to the bottom plate 304. This gasket may provide for the pressure of the fluid of the WIP to be evenly distributed across the top and bottom surface of the enclosed cell 206. As mentioned above, the fluid used in the isometric press may damage the battery cell 306 located within the frame 300 during the pressing of the battery cell. Thus, the frame 300, and one or more gaskets oriented within the frame, may prevent or reduce the amount of fluid contacting the battery cell 306 during pressing. Further, the dimensions of the frame 300 may reduce spreading of the layers of the battery cell 306 that may occur during pressing. In particular, the shape of the recesses, and frame 300 in general, may contain the layers or layer of the battery cell 306 within the recesses so that the layers substantially retain their shape during pressing.

The components of the frame 300 discussed above may be stacked to generate a housing, within which the battery cell 306 is located. For example, FIG. 5 shows an orientation of the components of the frame 300 to load a battery cell 306 into the housing device. The components of the frame 300 are the same or similar to those discussed above. In particular, the frame 300 includes a top plate 302 and a bottom plate 304, between which a battery cell 306 may be located. As illustrated, the battery cell 306 is placed against or within the center recess of the bottom plate 304. The top plate 302 is then pressed against the battery cell 306 to encase the battery cell within the housing between the plates.

To aid in sealing the top plate 302 to the bottom plate 304, one or more gaskets may be placed between the components. For example, a gasket may be located along the metal frame portion of the bottom plate 304 to mate with the metal frame portion of the top plate 302. This gasket may be made of a polymer, an inorganic composite, lead, magnesium, or combination thereof. The dimensions of this gasket are not limited, however. Other gaskets may be used to further seal the top plate 302 to the bottom plate 304. As mentioned above, the fluid used in the WIP may damage the battery cell 306 located within the frame 300 during the pressing of the battery cell. Thus, the frame 300, and one or more gaskets oriented within the frame, may prevent or reduce the amount of fluid contacting the battery cell 306. Further, the dimensions of the components of the frame 300 may reduce spreading of the layers of the battery cell 306 that may occur during pressing. In particular, the shape of the center recess of the top plate 302 and the bottom plate 304 may contain the layers or layer of the battery cell 306 so that the layer substantially retains its shape during pressing.

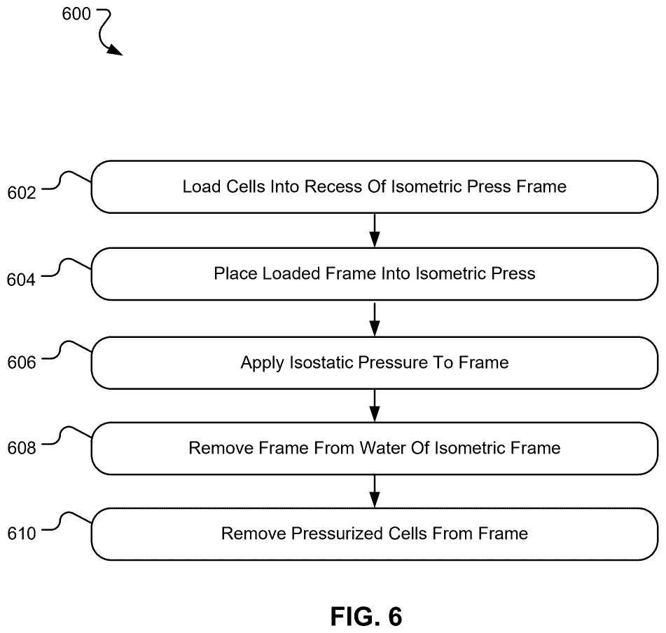

FIG. 6 is a flowchart of a method 600 for utilizing a frame 300 for applying uniaxial pressure to a battery cell 306 within an isostatic press. At step 602, a battery cell may be loaded into the recess or recesses of the frame 300. Although described herein for use with a battery cell, it should be appreciated that other battery cell types may be used with the frame 300, such as completed battery cells, unpouched battery cell stacks, stacks within an interim enclosure, and the like. In general, any stack of layers of a battery cell may be loaded into the recesses of the frame 300. For a frame 300 with corresponding recesses on opposing sides of the frame, the battery cell 306 may be loaded into both sides of the frame. As noted above, the frame recesses may be shaped and sized for the type of battery cell being loaded, including a battery cell with or without conductive tabs. In general, the recesses may be sized (e.g., have a shape and depth) to minimize or reduce the pressing force applied to the sides/edges of the battery cell.

In some instances, the battery cell may be sealed within the frame 300, and air removed from the sealed area housing the battery cell before it is pressurized. For example, at least a portion of the air within the frame 300 after mating of the top plate with the bottom plate may be removed from the interior of the mated frame, thereby at least partially evacuating the area where the battery cell is sealed within the frame. The air may be removed from the interior of the mated frame 300 through a vacuum process, in some instances. For example, FIG. 4 illustrates an example mated frame 300 that includes an optional vacuum port 330 through the frame extending from the outer surface of the frame to the interior of the mated frame. The vacuum port 330 may provide a sealable airway to which a vacuuming device, such as a vacuum pump, may be connected and access the interior of the mated frame 300 to evacuate at least a portion of the air within the frame interior. Upon removal of the vacuuming device, the port 330 may be sealed to maintain the vacuumed seal of the battery cell within the frame 300. For example, the vacuum port connection may include a valve the provides an airtight seal when the vacuum pump is disconnected.

At step 604, the loaded frame 300 may be placed within an isometric press and isostatic pressure may be applied to the battery cell 306 within the frame. As described above, the pressure from the isometric press may densify the layers of the stack of the battery cell and/or at least partially laminate the layers together through application of pressure force on the layers of the battery cell. After application of the pressure to the battery cell 306 from the isometric press at step 606, the frame 300 may be removed from the fluid of the isometric press at step 608. At step 610, the pressurized battery cell 306 may then be removed from the frame 300. As the frame maintains a barrier between the battery cell 306 and the fluid of the isometric press, the battery cell can be removed from the frame after pressing with no cleanup or de-masking. This may improve the speed at which densification and/or lamination of the layers of the battery cell 306 is completed. In addition, the frame 300 allows for densification and/or lamination of the battery cell, further streamlining the battery cell manufacturing process, without damaging portions of the battery cell due to isostatic pressure on the edges or small surfaces of the battery cells.

In the manner discussed, the top plate and the bottom plate of the housing form the opening through the housing to retain the battery cell within the opening. Opposing uniaxial pressing forces may be applied to both sides of the battery cell and the electrode stack within the battery cell. During the pressing, the frame 300 may protect the periphery of the battery cell and/or the tabs of the battery cell from damage from the pressure within the isostatic press.

Although various representative embodiments of this invention have been described above with a certain degree of particularity, those skilled in the art could make numerous alterations to the disclosed embodiments without departing from the spirit or scope of the inventive subject matter set forth in the specification. All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected to another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present disclosure.

While specific embodiments are discussed, it should be understood that this is done for illustration purposes only. A person skilled in the relevant art will recognize that other components and configurations may be used without parting from the spirit and scope of the disclosure. Thus, the above description and drawings are illustrative and are not to be construed as limiting. Numerous specific details are described to provide a thorough understanding of the disclosure. However, in certain instances, well-known or conventional details are not described in order to avoid obscuring the description.

Reference to “one embodiment” or “an embodiment” means that a particular feature, structure, or characteristic described in connection with the embodiment is included in at least one embodiment of the disclosure. The appearances of the phrase “in one embodiment”, or similarly and synonymously “in one example” or “in one instance”, in various places in the specification are not necessarily all referring to the same embodiment, nor are separate or alternative embodiments mutually exclusive of other embodiments. Moreover, various features are described which may be exhibited by some embodiments and not by others. The disclosure is not limited to various embodiments (examples, instances or aspects) given in this specification. Various modifications and additions can be made to the exemplary embodiments discussed without departing from the scope of the present invention. Accordingly, the scope of the present invention is intended to embrace all such alternatives, modifications, and variations together and in various possible combinations of various different features of different embodiments combined to form yet additional alternative embodiments, with all equivalents thereof.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. The term “about” or “substantially” will be understood by persons of ordinary skill in the art and will vary to some extent on the context in which it is used. As used herein when referring to some characteristic, a measurable value such as an amount, a temporal duration, and the like, the term “about” is meant to encompass variations of ±10%, including ±5%, ±1%, and ±0.1% from the specified value or characteristic, as such variations are appropriate to perform the disclosed methods. For example, being substantially uniaxial allows some deviation from perfectly uniaxial, such that the pressure from the isostatic press applies uniaxial forces on the battery cell but those forces may not be perfectly uniaxial and some or all or portions thereof may deviate by ±5%, ±1%, and ±0.1%.

Without intent to limit the scope of the disclosure, examples of instruments, apparatus, methods and their related results according to the embodiments of the present disclosure are given. Note that titles or subtitles may be used in the various embodiments for convenience of a reader, which in no way should limit the scope of the disclosure.

Various features and advantages of the disclosure are set forth in the description above, and in part will be obvious from the description, or can be learned by practice of the herein disclosed principles. The features and advantages of the disclosure can be realized and obtained by means of the instruments and combinations particularly pointed out in the appended claims.

What is claimed is:

1. A frame for protection of a solid-state battery cell during pressing, the frame comprising:
a first plate mated with a second plate, the first plate comprising a rigid outer perimeter frame and an inner portion comprising a flexible material covering the inner portion;
wherein the second plate comprises an inset to receive the solid-state battery cell to position the solid-state battery cell between the first plate and the second plate when mated, the flexible material covering the inner portion providing for a pressurizing of the solid-state battery cell via an isostatic press applying a pressing force through the flexible material of the first plate onto at least one layer of a plurality of layers of the solid-state battery cell, the rigid frame preventing the pressing force on an end of the solid-state battery cell.

2. The frame of claim 1, wherein dimensions of the inner portion of the first plate comprise a length less than or equal to the length of a first layer of the plurality of layers of the solid-state battery cell or a width less than or equal to width of the first layer of the plurality of layers of the solid-state battery cell.

3. The frame of claim 2, wherein the solid-state battery cell comprises a second layer of the plurality of layers of the solid-state battery cell, the second layer comprising dimensions larger than the first layer of the solid-state battery cell.

4. The frame of claim 3, wherein the first plate further comprises:
a recessed shelf around a perimeter of the inner portion, wherein the dimensions of the recessed shelf comprise a length greater than or equal to the length of the second layer of the plurality of layers of the solid-state battery cell or a width greater than or equal to width of the second layer of the plurality of layers of the solid-state battery cell.

5. The frame of claim 1, wherein the second plate comprises a second rigid outer perimeter surrounding a second inner portion comprising the flexible material covering the second inner portion.

6. The frame of claim 1, wherein the second plate further comprises:
a center recess corresponding to the inset of the second plate; and
a conductive tab recess extending from the inner portion inset of the second plate to receive a conductive tab of the solid-state battery cell.

7. The frame of claim 6, wherein the second plate further comprises:
a weld recess extending from the inset of the second plate and proportioned to receive a weld portion of the solid-state battery cell.

8. The frame of claim 6, wherein the center recess of the inset of the second plate comprises one or more rigid walls surrounding the solid-state battery cell to reduce expansion of one or more sidewalls of the solid-state battery cell during application of the pressing force.

9. The frame of claim 1, wherein the pressing force densifies the at least one layer of the plurality of layers of the solid-state battery cell.

10. The frame of claim 1 further comprising:
a gasket between the first plate and the second plate to from a seal between the first plate and the second plate.

11. The frame of claim 10, wherein the gasket engages the rigid outer perimeter of the first plate or the second plate.

12. The frame of claim 1, wherein the flexible material is a polymer material.

13. A method for applying force to layers of a solid-state battery cell, the method comprising:
loading the solid-state battery cell in a first plate of a frame, the first plate comprising a first rigid outer perimeter and a first inner portion comprising a flexible material covering the inner portion;
mating the first plate with a second plate to encase the solid-state battery cell within the frame between the second plate and the first plate, the second plate comprising a second rigid outer perimeter and a second inner portion comprising a second flexible material covering the inner portion; and
pressurizing, through an isostatic press, the solid-state battery cell, the isostatic press applying a pressing force to a layer of the solid-state battery cell through the first inner portion and the second inner portion via the flexible material.

14. The method of claim 13, wherein the isostatic press is a warm, isostatic press (WIP) device.

15. The method of claim 13 further comprising:
locating a gasket between the first rigid outer perimeter and the second rigid outer perimeter prior to mate the first plate with the second plate.

16. The method of claim 15, wherein mating the first plate with the second plate fluidly isolates the solid-state battery cell within the frame.

17. The method of claim 13, wherein the solid-state battery cell further comprises a plurality of layers and a conductive tab extending from at least one of the plurality of layers, the first plate of the frame including a portion shaped to receive and support the conductive tab.

18. The method of claim 13, wherein the solid-state battery cell further comprises a plurality of layers and a welded portion extending from at least one of the plurality of layers, the first plate of the frame including a portion shaped to receive and support the welded portion.

19. The method of claim 13 wherein pressurizing the solid-state battery cell at least partially laminates two or more of a plurality of layers of the solid-state battery cell.

20. The method of claim 13, wherein the flexible material is a polymer material.

21. The method of claim 13, further comprising, prior to pressurizing, through an isostatic press, the solid-state battery cell, evacuating air from an interior of the frame between the second plate and the first plate where the solid-state battery is encased.

22. A frame for a high-pressure environment, the frame comprising:
a first plate comprising a first rigid outer perimeter frame and a first inner portion comprising a first flexible material covering the first inner portion;
a second plate for mating with the first plate, the second plate comprising a second rigid outer perimeter frame and a second inner portion comprising a second flexible material covering the second inner portion; and
wherein the second plate comprises an inset to receive an electrochemical object to position the electrochemical object between the first plate and the second plate when mated, the flexible material covering the first inner portion and the second inner portion providing for an isostatic pressurizing of a least a portion of the electrochemical object via a press applying a pressing force through the first flexible material and the second flexible material onto electrochemical object.
